(19) United States
(12) Patent Application Publication
(10) Pub. No.: US 2008/0256117 A1
(43) Pub. Date: Oct. 16, 2008

(54) Managing entity data in case of multiple entity identities

(75) Inventors: Antti Laurila, Helsinki (FI); Eva-Maria Leppanen, Lempaala (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/787,208

(22) Filed: Apr. 13, 2007

(51) Int. Cl. G06F 7/00

(52) U.S. Cl. 707/102; 707/E17.005

(57) ABSTRACT

A method manipulates data that is or is to be stored at a server. The data has to be identifiable at the server via a data identifier that comprises an entity identity identifying an entity. A set of entity identities identifying the entity exists and comprises a primary entity identity and one or more other entity identities. The data is specific for the set of entity identities. The data is always identified in the manipulating via a data identifier comprising the primary entity identity. A method further stores such entity-specific data at a server. The data is stored only under the primary entity identity, and the data is associated with the other entity identities so that the data is also identifiable via a data identifier comprising one of the other entity identities. The invention further relates to corresponding devices, computer program products and a system.

### FIELD OF THE INVENTION

This invention relates to methods, devices, computer program products and a system in the field of manipulating entity data in case of multiple entity identities.

### BACKGROUND OF THE INVENTION

The Open Mobile Alliance (OMA) has defined a generic framework for Extensible Markup Language (XML) Document Management (XDM) which defines a common mechanism that makes user-specific service-related information accessible to service enablers that need them (cf. document “XML Document Management Architecture”, Open Mobile Alliance, Approved Version 1.0, 12 Jun. 2006, document code “OMA-AD-XDM-V1_{—}0-20060612-A”). Such information is expected to be stored in a network where it can be located, accessed and manipulated (created, changed, deleted, etc.). XDM specifies how such information is defined in well-structured XML documents, as well as the common protocol for access and manipulation of such XML documents. The XML Configuration Access Protocol (XCAP), as defined by the Internet Engineering Task Force (IETF) (cf. “The Extensible Markup Language (XML) Configuration Access Protocol (XCAP)”, Rosenberg, J., Oct. 13, 2006, document code “draft-ietf-simple-xcap-12”), has been chosen as the common XML Document Management protocol.

Documents accessed and manipulated via XCAP are stored in logical repositories in the network, called XML Document Management Servers (XDMS). Each repository may be, associated with a functional entity which uses its data to perform its functions. Access and manipulation of the documents may for instance be requested by an XDM client.

XCAP defines XCAP Uniform Resource Identifiers (URIs) for accessing data in XML format as two parts: document selector, which chooses the XML document, and node selector, which chooses the XML component (element, attribute) inside the XML document.

The syntax of the XCAP URI is fixed, meaning that the XML documents are organized into a mandatory hierarchy 100, which is illustrated in FIG. 1.

In the top level there is the Root Services URI 101, which identifies the start of the XCAP tree (corresponding to the address of an aggregation proxy), e.g. “http://xcap.example.com”. The next level is the Application Unique ID (AUID) 102, which identifies the used service or application, e.g. “org.openmobilealliance.poc-groups” in case of a Push-to-Talk over Cellular (PoC) service related “group” specific application usage. Alternative AUIDs are for instance IM history and deferred messages metadata, shared user access policy, shared URI list and shared user profile.

The following hierarchical level is either the “users” 103 or “global” 104 directory, where the “users” tree 103 contains documents per user and the “global” tree 104 is for data that is not user-specific.

Within the “users” tree 103, the next hierarchical level is the XCAP User Identity (XUI), e.g. of a first user 105 and a second user 106, which defines where a requested user's XDM documents are stored. The XUI may for instance be a Session Initiation Protocol (SIP) URI or a TEL URI, to name but a few examples. A SIP URI for the second user 106 may for instance be “sip:ronald.underwoord@example.com”.

In FIG. 1, document “doc1”, which may for instance be an XML document denoted as “access.xml”, is stored under the XUI of the second user 106. Underneath the XUI level, there may still be other miscellaneous directories 108 which eventually lead to the actual XML documents.

In FIG. 1, combining the examples given above, XML document 107 is then identified by the XCAP URI “http://xcap.example.com/org.openmobilealliance.poc-groups/users/sip:ronald.underwood@example.com/access.xml”

An XCAP URI may also contain an XPATH reference to a node in the XML document allowing access to a specific XML element or attribute within the XML document. An example of such an XCAP URI is the following (the XML node reference is after the double tilde symbol ˜˜): http://xcap.example.com/org.openmobilealliance.poc-groups/users/sip:ronald.underwood@example.com/myconf/˜˜/conference[1]/settings/conference-uri.

OMA further defines the Converged Internet Protocol (IP) Messaging (CPM), which is a communication framework that accommodates different user experiences such as deferred and immediate messaging, session-based communication, and half duplex/full duplex conferencing (cf. “Converged IP Messaging Architecture”, Open Mobile Alliance, Draft Version 1.0, 20 Mar. 2007, document code “OMA-AD-CPM-V1_{—}0-20070320-D). CPM aims at consolidating common functionalities of existing messaging services and new features introduced by the convergence of communications brought by SIP-based technologies. It interacts with other OMA “supporting” enablers such as Presence and XDM.

Considering today's diverse user experiences in various service domains, the CPM enabler aims to provide a consistent user experience across many service domains for all IP networks (mobile, home, Internet worlds) by addressing the service constraints in a bearer-agnostic manner. Another feature of CPM is the interoperability between different service providers (including roaming conditions).

CPM is targeted to provide a converged messaging capability focusing on the user experiences provided with the following services: Text messaging enabled services (e.g. Short Message Service (SMS), Instant Messaging and Presence Service (IMPS), SIMPLE Instant Messaging (IM), Email, Multimedia Messaging Service (MMS)), Voice-enabled services (e.g. PoC, Voice-over-IP (VoIP)) and Video-enabled service (e.g. Video-o-IP).

In CPM, it is desired that a CPM user can have a common set of preference settings for all or a subset of his/her CPM addresses. Additionally, it is required that configuration and preference settings are supported on a per-address basis.

### SUMMARY

One possibility to manage a user's preference settings is via XDM, i.e. to store the user's preference settings as XML document(s) at one or more XDM Servers and to use the XCAP for locating, accessing and manipulating the user's preference settings.

Since the XCAP URI syntax as described above contains the XUI part having a user's address as a value (see XUIs 105 and 106 in FIG. 1), it is currently not possible to have common preference settings (stored only once) for multiple addresses or identities for the user. Only the approach of having separate, independent preference settings for all the possible addresses of a user is supported. This means that the user has XML information stored at an XDMS with one of his addresses (e.g. XUI is based on user's SIP URI), and the information should be available also with other user's addresses (e.g. another URI of the user).

According to a first aspect of the present invention, a method is disclosed, the method comprising manipulating data that is or is to be stored at a server, which data has to be identifiable at the server via a data identifier that comprises an entity identity identifying an entity, wherein a set of entity identities identifying the entity exists and comprises a primary entity identity and one or more other entity identities, wherein the data is specific for the set of entity identities, and wherein the data is always identified in the manipulating via a data identifier comprising the primary entity identity. The method may for instance be performed by a client. The client may for instance be an XDM client.

According to the first aspect of the present invention, furthermore a computer-readable medium having a computer program stored thereon is disclosed, the computer program comprising instructions operable to cause a processor to manipulate data that is or is to be stored at a server, which data has to be identifiable at the server via a data identifier that comprises an entity identity identifying an entity, wherein a set of entity identities identifying the entity exists and comprises a primary entity identity and one or more other entity identities, wherein the data is specific for the set of entity identities, and wherein the data is always identified in the manipulating via a data identifier comprising the primary entity identity. The computer-readable medium may for instance be embodied as an electric, magnetic, electro-magnetic or optic storage medium, and may either be a removable medium or a medium that is fixedly installed in a device. The computer program is also understood to be disclosed per se, i.e. without being stored on the computer readable-medium.

According to the first aspect of the present invention, furthermore a device is disclosed, comprising a processing unit configured to manipulate data that is or is to be stored at a server, which data has to be identifiable at the server via a data identifier that comprises an entity identity identifying an entity, wherein a set of entity identities identifying the entity exists and comprises a primary entity identity and one or more other entity identities, wherein the data is specific for the set of entity identities, and wherein the processing unit is further configured to identify the data in the manipulating always via a data identifier comprising the primary entity identity. The device may for instance be a client or a part thereof. The client may for instance be an XDM client.

According to the first aspect of the present invention, data that is or is to be stored at a server is manipulated. The entity may for instance be one or more users or a device, to name but a few possibilities. The data may for instance be stored in a directory structure at the server. The manipulating of the data may for instance comprise putting data to the server for storage, retrieving data from the server, deleting data from the server, and changing data on the server, to name but a few possibilities. The manipulating may for instance be performed or initiated by a client, and may be based on a specific protocol, for instance the XCAP.

The data that is or is to be stored at the server has to be identifiable at the server via a data identifier that comprises an entity identity. The data identifier may for instance be an XCAP URI. The entity identity may for instance be an XUI.

A set of entity identities exists, wherein all of the entity identities in the set identify the entity. For instance, in case the entity identities are XUIs, one entity identity may be a SIP URI, and another entity identity may be a TEL URI, wherein both entity identities identify the same entity. The set of entity identities may not contain all existing entity identities that identify the entity.

The set of entity identities comprises a primary entity identity and other entity identities. The primary entity identity may for instance be an entity identity that shall preferably be used for storing and/or manipulating the data.

The data is specific for the set of entity identities. The data may for instance be the same for all entity identities in said set of entity identities. This does not inhibit further data that is specific for further entity identities, but not specific for the set of entity identities, and/or further data that is specific for one or more, but not all entity identities of said set of entity identities, to be also stored at the server.

Thus the data may be understood to represent data that is specific for the entity and also for the entity identities, i.e. the data may form an intersection of entity identity-specific data. It may well be possible to still store entity-identity-specific data that does not intersect with other entity-identity-specific data under one of the other entity identities at the server. When manipulating the data, always a data identifier comprising the primary entity identity is used to identify the data. Thus even when the other entity identities are in use, for instance in a communication of a client with other units, the client always uses the primary entity identity in the data identifier.

Always identifying the data via a data identifier comprising the primary entity identity causes the data to be stored and/or maintained at the server under the primary entity identity only. In this way, a centralized data storage at the server is achieved, for instance in cases where several clients manipulate the data. In particular when each of these clients uses a different entity identity in the data identifier when manipulating the data, the data may be caused to be stored and/or maintained at the server under different entity identities. This is avoided by introducing a primary entity identity and demanding that clients always use this primary entity identity when manipulating the data.

According to an exemplary embodiment of the first aspect of the present invention, the primary entity identity is a default entity identity. The primary entity identity may for instance be a default entity identity for storing and/or manipulating the data. It may for instance be prescribed by a rule or a protocol which entity identity is to be used as the primary entity identity. The primary entity identity may be fixedly stored in a device according to the first aspect of the present invention, or may be stored on a storage medium inserted into such a device, e.g. a memory card such as a Universal Subscriber Identity Module (USIM) card.

According to a further exemplary embodiment of the first aspect of the present invention, the data is a document or a part thereof that is or is to be stored at an extensible markup language document management server, the data identifier is an extensible markup language configuration access protocol uniform resource identifier and the entity identities are extensible markup language configuration access protocol user identities. The XUIs may for instance comprise a SIP URI and a TEL URI, to name but a few possibilities.

According to a further exemplary embodiment of the first aspect of the present invention, the data describes a common set of preference settings for all or a subset of an entity's entity identities.

According to a further exemplary embodiment of the first aspect of the present invention, said data describes a common address book for all or a subset of an entity's entity identities.

According to a further exemplary embodiment of the first aspect of the present invention, said entity identities are said entity's converged internet protocol messaging addresses. The entity may then for instance be a CPM user, the entity identities may for instance be the CPM user's addresses supported by the CPM, and the data may describe the user's CPM preference settings or his CPM common address book.

According to a second aspect of the present invention, a method is disclosed, comprising storing data at a server, which data has to be identifiable at the server via a data identifier that comprises an entity identity identifying an entity, wherein a set of entity identities identifying the entity exists and comprises a primary entity identity and one or more other entity identities, wherein the data is specific for the set of entity identities, wherein the data is stored only under the primary entity identity, and wherein the data is associated with the other entity identities so that the data is also identifiable via a data identifier comprising one of the other entity identities. The method may for instance be performed by a server. The server may for instance be an XDM server.

According to the second aspect of the present invention, furthermore a computer-readable medium having a computer program stored thereon is disclosed, the computer program comprising instructions operable to cause a processor to store data at a server, which data has to be identifiable at the server via a data identifier that comprises an entity identity identifying an entity, wherein a set of entity identities identifying the entity exists and comprises a primary entity identity and one or more other entity identities, wherein the data is specific for the set of entity identities, wherein the data is stored only under the primary entity identity, and wherein the data is associated with the other entity identities so that the data is also identifiable via a data identifier comprising one of the other entity identities. The computer-readable medium may for instance be embodied as an electric, magnetic, electro-magnetic or optic storage medium, and may either be a removable medium or a medium that is fixedly installed in a device. The computer program is also understood to be disclosed per se, i.e. without being stored on the computer readable-medium.

According to the second aspect of the present invention, furthermore a device is disclosed, comprising a storage unit configured to store data at a server, which data has to be identifiable at the server via a data identifier that comprises an entity identity identifying the entity, wherein a set of entity identities identifying the entity exists and comprises a primary entity identity and one or more other entity identities, wherein the data is specific for the set of entity identities, wherein the data is stored only under the primary entity identity, and wherein the data is associated with the other entity identities so that the data is also identifiable via a data identifier comprising one of the other entity identities. The device may for instance be a server or a part thereof. The server may for instance be an XDM server.

According to the second aspect of the present invention, data is stored at a server. The entity may for instance be one or more users or a device, to name but a few possibilities. The data may for instance be stored in a directory structure at the server. The data may for instance be stored during or after a manipulation of the data which is performed by a client, wherein the manipulation may for instance comprise putting, retrieving, deleting or changing the data.

The data that is stored at the server has to be identifiable at the server via a data identifier that comprises an entity identity. The data identifier may for instance be an XCAP URI. The entity identity may for instance be an XUI.

A set of entity identities exists, wherein all of the entity identities identify the same entity. For instance, in case the entity identities are XUIs, one entity identity may be a SIP URI, and another entity identity may be a TEL URI, wherein both entity identities identify the same entity. The set of entity identities may not contain all existing entity identities that identify the entity.

The set of entity identities comprises a primary entity identity and other entity identities. The primary entity identity may for instance be an entity identity that shall preferably be used for storing and/or manipulating the data.

The data is specific for the set of entity identities. The data may for instance be the same for all entity identities in said set of entity identities. This does not inhibit further data that is specific for further entity identities, but not specific for the set of entity identities, to be also stored at the server.

Thus the data may be understood to represent data that is specific for the entity and also for the entity identities, i.e. the data may form an intersection of entity identity-specific data. It may well be possible to still store entity-identity-specific data that does not intersect with other entity-identity-specific data under one of the other entity identities at the server. The data is only stored under the primary entity identity, for instance in a directory tree below the primary entity identity. Thus although several entity identities which identify the same entity and for which the data is specific exist, under which entity identities the data could be stored, the data is only stored once, so that, inter alia, centralized data management can be performed and also memory space is saved. Storing the data only under the primary entity identity may be caused by one or more clients that, when manipulating the data, always use the primary entity identity in the data identifier to identify the data. Alternatively, the server or another instance may decide that the entity-specific data has to be stored only under the primary entity identity, for instance during a set-up and/or configuration of said server.

To allow that the data is also identifiable via data identifiers comprising the other entity identities (of said set of entity identities), the data stored under the primary entity identity is associated with the other entity identities. This association may for instance be created based on links/pointers, or on rules prescribing how and/or where (for instance in a directory structure) the other entity identities have to be stored to be understood to be associated with the data. This association may for instance be created by the server on which the data is stored, or by an operator, or by clients that manipulate the data, to name but a few possibilities.

According to a first exemplary embodiment of the second aspect of the present invention, the data stored under the primary entity identity is associated with the other entity identities by providing, under each of the other entity identities, a pointer pointing to the data stored under the primary entity identity. Under one or more of the other entity identities, further data that is only specific for the respective entity identity, but not for all entity identities of the set of entity identities, may be stored.

In this first exemplary embodiment of the second aspect of the present invention, a unit may be prepared to find the pointer instead of the data when identifying the data via the data identifier that comprises one of the other entity identities.

In this first exemplary embodiment of the second aspect of the present invention, the primary entity identity and the other entity identities may be stored in the same level of a directory structure. Therein, a global document may comprise information on the directory structure, and a mapping between the other entity identities and the primary entity identity may then be derivable from the global document. The global document may for instance be stored in a pre-defined directory position, e.g. the global directory of an XCAP URI directory.

According to a second exemplary embodiment of the second aspect of the present invention, the data stored under the primary entity identity may be associated with the other entity identities by storing the other entity identities under the primary entity identity. The other entity identities may for instance be stored under the primary entity identity by gathering them in a folder below the primary entity identity. Under one or more of the other entity identities, further data that is only specific for the respective entity identity, but not for all entity identities of the set of entity identities, may be stored.

In this second exemplary embodiment of the second aspect of the present invention, an index mapping the other entity identities to the primary entity identity may be provided. The index may be used to identify the data via the data identities.

In this second exemplary embodiment of the second aspect of the present invention, a global document may comprise information on a directory structure in which the entity identities are stored, and a mapping between the other entity identities and the primary entity identity may be derivable from the global document. The global document may for instance be stored in a pre-defined directory position, e.g. the global directory of an XCAP URI directory.

According to a third exemplary embodiment of the second aspect of the present invention, the primary entity identity is a default entity identity. The primary entity identity may for instance be a default entity for storing and/or manipulating the data. It may for instance be prescribed by a rule or a protocol which entity identity is to be used as the primary entity identity. The primary entity identity may for instance be fixedly stored in a client that manipulates the data at the server, or may be stored on a storage medium inserted into the client, e.g. a memory card such as a Universal Integrated Circuit Card (UICC) comprising a Universal Subscriber Identity Module (USIM).

According to a fourth exemplary embodiment of the second aspect of the present invention, the data is a document or a part thereof that is or is to be stored at an extensible markup language document management server, the data identifier is an extensible markup language configuration access protocol uniform resource identifier and the entity identities are extensible markup language configuration access protocol user identities. The XUIs may for instance comprise a SIP URI and a TEL URI, to name but a few possibilities.

According to a fifth exemplary embodiment of the second aspect of the present invention, the data describes a common set of preference settings for all or a subset of an entity's entity identities

According to a sixth exemplary embodiment of the second aspect of the present invention, said data describes a common address book for all or a subset of an entity's entity identities.

According to a seventh exemplary embodiment of the second aspect of the present invention, said entity identities are said entity's converged internet protocol messaging addresses. The entity may then for instance be a CPM user, the entity identities may for instance be the CPM user's addresses supported by the CPM, and the data may describe the user's CPM preference settings or his CPM common address book.

According to a third aspect of the present invention, a system is disclosed, comprising a device according to the first aspect of the present invention and a device according to the second aspect of the present invention. The system may for instance implement an XDM architecture. The device according to the first aspect of the present invention then always uses the primary entity identity to identify the entity-specific data that is or is to be stored at the server, and the device according to the second aspect of the present invention, which may for instance be the server, stores the entity-specific data only under the primary entity identity, and associates the data also with the other entity identities so that the data can also be identified via a data identifier comprising one of the other entity identities.

These and other aspects of the invention will be apparent from and elucidated with reference to the detailed description presented hereinafter. The features of the present invention and of its exemplary embodiments as presented above are understood to be disclosed also in all possible combinations with each other.

### BRIEF DESCRIPTION OF THE FIGURES

In the figures show:

FIG. 1: an exemplary illustration of a directory structure for storing an XML document at an Extensible Markup Language (XML) Document Management (XDM) server;

FIG. 2 a schematic block diagram of an exemplary embodiment of a system according to the present invention;

FIG. 3: a flowchart of an exemplary method according to a first aspect of the present invention;

FIG. 4: a flowchart of an exemplary method according to a second aspect of the present invention;

FIG. 5: an exemplary illustration of a directory structure for storing an Extensible Markup Language (XML) document at an XML Document Management (XDM) server according to the present invention;

FIG. 6: a further exemplary illustration of a directory structure for storing an XML document at an XDM server according to the present invention;

FIG. 7: an illustration of an exemplary use case of the present invention; and

FIG. 8: a schematic block diagram of a Converged Internet Protocol (IP) Messaging (CPM) architecture 800.

### DETAILED DESCRIPTION OF THE INVENTION

In the following detailed description of the present invention, exemplary embodiments of the present invention will be described in the context of an Extensible Markup Language (XML) Document Management (XDM) architecture that is deployed in a Converged Internet Protocol (IP) Messaging (CPM) framework to enable having a common set of user preferences for all or a subset of a CPM user's CPM addresses. It is readily clear that the present invention is not limited to deployment of an XDM architecture in CPM only, it also works well with other enablers that use XDM (or XCAP), such as for instance Push-to-Talk over Cellular (PoC) and SIMPLE Instant Messaging (SIMPLE IM). Furthermore, the present invention is not limited to use in conjunction with an XDM architecture at all. The present invention may equally well be deployed in any context where entity-specific data has to be manipulated/stored in case of multiple entity identities.

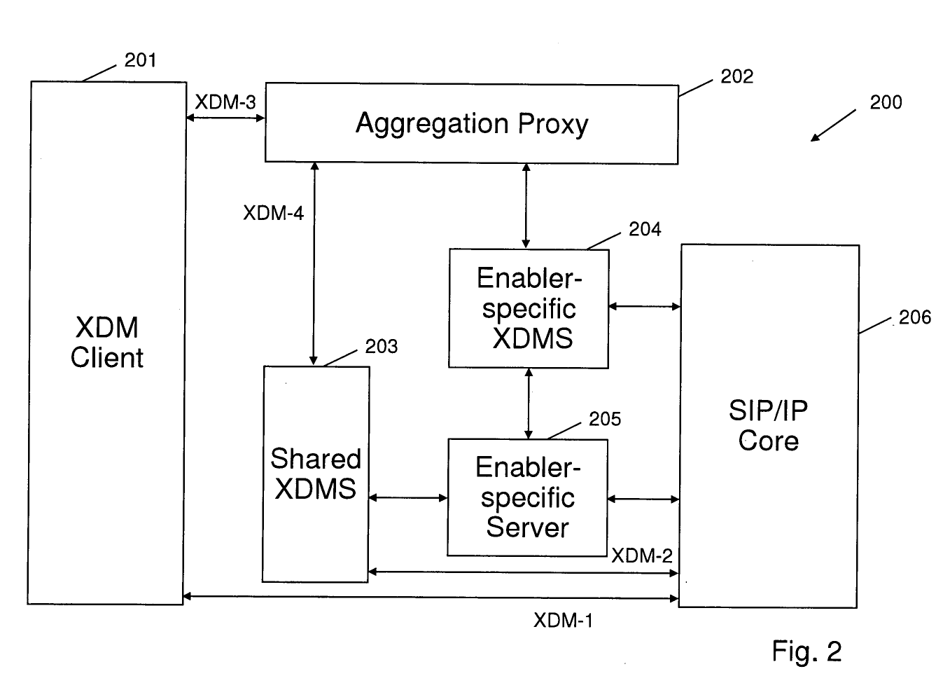

FIG. 2 is a schematic block diagram of an exemplary embodiment of a system 200 according to the present invention. The system comprises an XDM client 201, an aggregation proxy 202, a shared XDMS 203, an enabler-specific XDM server (XDMS) 204, an enabler-specific server 205 and a Session Initiation Protocol (SIP)/IP core 206. Therein, the description of the XDM architecture, the XML Configuration Access Protocol (XCAP) and the XCAP Uniform Resource Identifier (URI) as presented in the opening part of this specification is understood to be basically applicable also to the system 200 of FIG. 2.

XDM client 201 provides access to the features of shared XDMS 203 and enabler-specific XDMS 204. In particular, XDM client 201 is configured to manipulate data that is or is to be stored at shared XDMS 203 and/or enabler-specific XDMS 204, for instance putting, retrieving, deleting or changing an XML document or an XML element or an XML attribute at XDMS servers 203 and/or 204. XDM client 201 may be implemented in a terminal or in a server. It may particularly be implemented in software that is executed by a processor, wherein the software may be stored on a computer-readable medium, which may be fixedly installed in the terminal or server or may be removable.

Aggregation proxy 202 serves as a contact point for XDM client 201 to access and manipulate XML documents stored in XDMS 203 and/or 204. It may for instance authenticate XDM client 201, and perform routing of XCAP requests to the correct XDMS.

Shared XDMS 203 may contain multiple XDM servers which can be used by different service enablers. Enabler-specific XDMS 204 manages XML documents of a specific service enabler, such as for instance the CPM enabler, which will be discussed in more detail below. Both XDMS 203 and 204 support manipulation of XML documents stored at XDMS 203 and 204, and support SIP subscription/notification, allowing XDM client 201 to subscribe to notification of changes to an XML document in an XDMS. XDMS 203 and 204 may for instance be implemented in software that is executed by a processor, wherein the software may be stored on a fixedly installed or removable computer-readable medium.

Similarly, enabler-specific server 205 is related to a specific service enabler, such as for instance the CPM enabler. The enabler-specific server 205 may use XDM servers in a similar way as XDM clients do.

SIP/IP core 206 represents a network of servers, e.g. proxies and/or registrars that support certain functions of the XDM service. In particular, routing of the SIP signaling between the XDM client 201 and the XDMS 203 and 204 is performed by SIP/IP core 206.

FIG. 2 further illustrates reference points XDM-1 to XMD-4. Reference point XDM-1 provides subscription to and notification of modifications of any XML documents via SIP/IP core 206 using SIP. Reference point XDM-2 provides subscription to and notification of modification of shared XML documents at shared XDMS 203 via SIP. Reference point XMD-3 provides authentication and XML document management (e.g. document manipulation) via XCAP. Reference point XMD-4 provides shared XML document management (e.g. manipulation) via XCAP. Similar reference points can be defined with respect to enabler-specific XDMS 204, for instance a reference point for subscription to and notification of modifications of XML documents at XDMS 204 via SIP between SIP/IP core 206 and enabler-specific XDMS 204, and a reference point for XML document management (e.g. manipulation) via XCAP between the aggregation proxy 202 and enabler-specific XDMS 204.

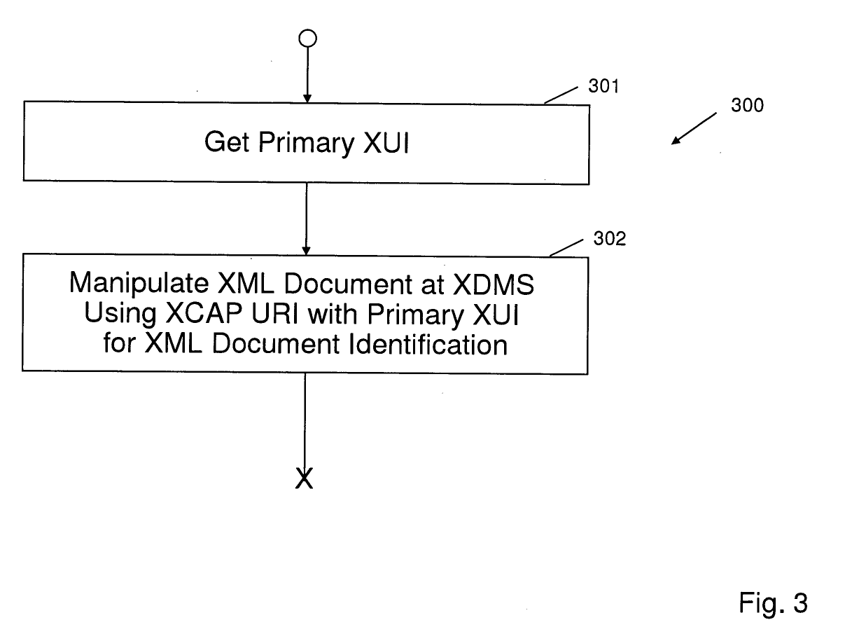

FIG. 3 depicts a flowchart 300 of an exemplary embodiment of a method according to the first aspect of the present invention. This method may for instance be performed by XDM client 201 of system 200 of FIG. 2.

In a first step 301, the XDM client gets a Primary XUI. This Primary XUI may for instance be stored in a device that implements the XDM client, e.g. a User Equipment (UE), or may be obtained by said XDM client from an external instance, e.g. a specific server such as a client/device provisioning server. This may for instance be a server dedicated to client provisioning or device management; it could also be a more general provisioning server containing user specific (service) subscription information, but also taking care of certain terminal configurations. For instance, a device management server may be used by a service provider to set up service configurations remotely in the terminal device by using the device management mechanism. Updates of service configurations are then remotely performed in the terminal device, and a UE comprising a device management client is able to receive the content sent by the service provider. Therein, the device management server performs such initializations and updates of all required configuration parameters.

Said Primary XUI may equally well be determined by the XDM client from a plurality of different XUIs based on a pre-defined rule or protocol.

In a second step 302, the XDM client manipulates (e.g. creates) an XML document which is stored at an XDMS (e.g. shared XDMS 203 or enabler-specific XDMS 204 of system 200 of FIG. 2) using an XCAP URI including the Primary XUI to identify the XML document.

The present invention introduces the “Primary XUI” concept, where “end-user” specific data is stored by default. For instance, the Primary XUI could be one of the user's Public User Identifiers (PUIs) or a private ID or some else user identifier. Using one of a user's public identities may be support to backward compatibility reasons.

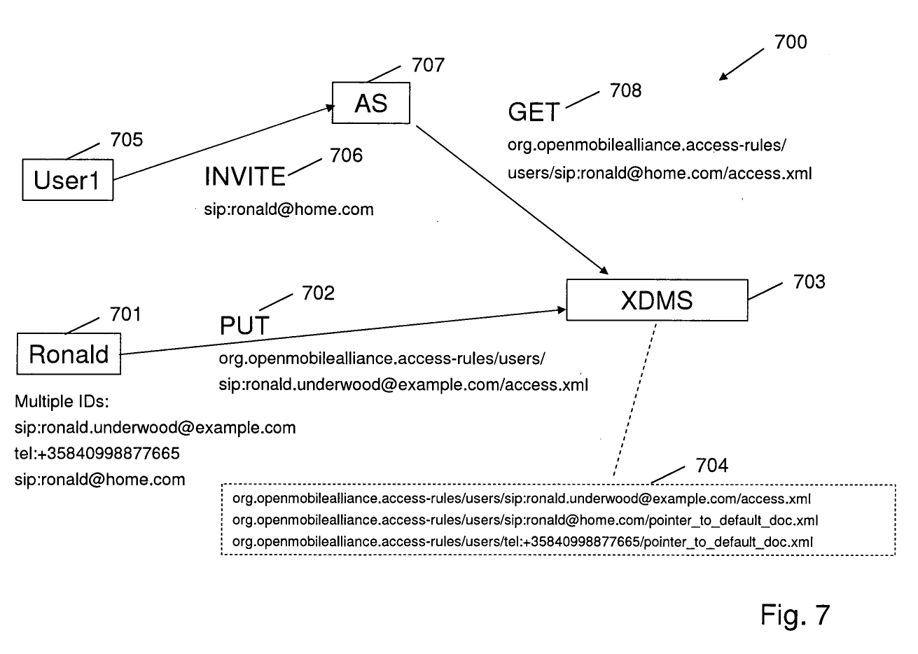

Therein, it is to be noted that the XCAP is only used to control all kinds of manipulation (putting, retrieving, deleting, changing, etc.) of XML documents stored at the XDMS (see for instance reference points XDM-3 and XDM-4 in FIG. 2). However, in the actual communication traffic (such as for instance speech that is controlled by an application server such as for instance a PoC server), the SIP is used (for instance in a PoC SIP INVITE message, see FIG. 7) with the Public User Identity (PUI), which may for instance be in the form of a SIP URI or a TEL URI (a telephone number). The PUI has to be provisioned/stored to the device that implements the XDM client (e.g. a UE), for instance taken from a Universal Subscriber Identity Module (USIM) card.

So the device that implements the XDM client may be required, in particular if the Primary XUI does not equal the PUI, to perform a mapping between the PUI and the Primary XUI when it manipulates XML documents stored at the XDMS servers via the XCAP.

The XDM client will always use the Primary XUI with all XCAP requests (e.g. GET, PUT, DELETE) for accessing data (XML documents) at the XDMS even if it may have multiple SIP URIs in use. By doing so, all the user's data will be stored at the XDMS at the same directory using the same user's tree (Primary XUI), except when it is really intentional to have URI/XUI-specific data.

The Primary XUI may for instance be provisioned to the XDM client in the same way as other service related parameters are provisioned (such as for instance an address of the home aggregation proxy 202 of system 200 of FIG. 2) in XDM Version 1 and 2, i.e. the operator may automatically push the Primary XUI to the XDM client, when a user takes the XDM service (XDM client) into use.

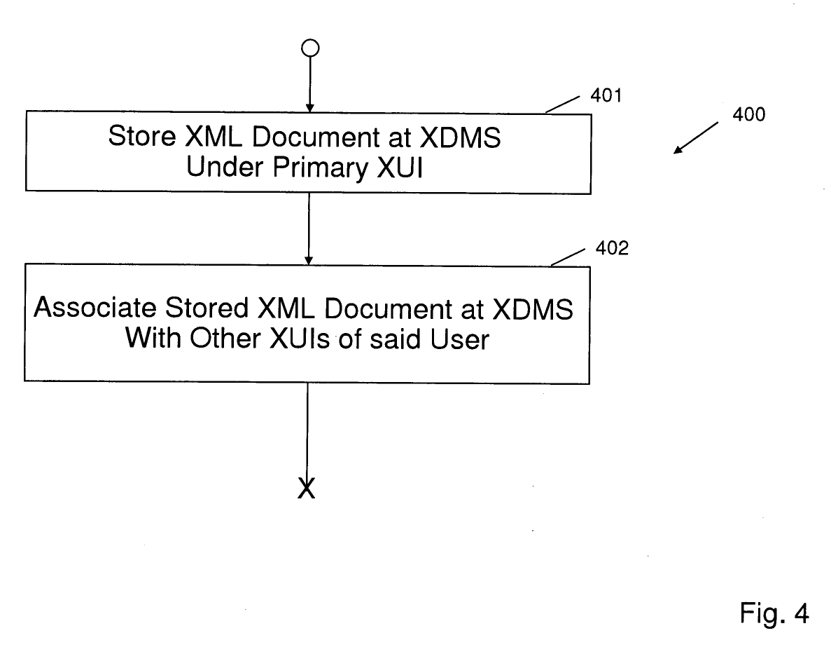

FIG. 4 depicts a flowchart 400 of an exemplary embodiment of a method according to the second aspect of the present invention. This method may for instance be performed by shared XDMS 203 or enabler-specific XDMS 204 of system 200 of FIG. 2.

In a first step 401, an XML document is stored (or, in other words, “created”) at the XDMS under a Primary XUI. This step may for instance be performed in response to a request of an XDM client for manipulation of the XML document, wherein the XML document has been identified in said request via an XCAP URI that comprises the Primary XUI.

In a second step 402, XDMS associates the stored XML document with other XUIs that identify the same user, to allow that the XML document can be identified via XCAP URIs that include XUIs that differ from the Primary XUI. In some cases, the association may have been done also earlier as a kind of default function.

Since an application server (AS) (see for instance FIG. 7 and its description below) generally receives SIP requests (for instance a SIP INVITE request issued by a user A to start a communication service with another user B) with any alias of a user's addresses (e.g. the TEL URI of user B), it may need to fetch service configuration information (i.e. a user access policy document that describes who is allowed to communicate with user B and who is not) first from the XDMS by the XCAP, but it may not or may not even be able to always use the Primary XUI when accessing XDMS data. Thus it may be useful that the XDMS is able to map all related XUIs to the Primary XUI. When the AS will fetch XDMS data based on any related XUI, the XDMS then will return the default document under the Primary XUI instead, provided that there is no XUI-specific data available.

The XDMS may for instance be provided with information on the different XUIs of a user by the XDM clients, or by an operator of a network in which the XDM architecture is used. The operator may for instance take care of automatically creating directories and providing the required information on some or all XUIs of a user.

In step 402 of FIG. 4, it is exemplarily assumed that the XML document stored under the Primary XUI is specific for all XUIs of the user, so that it is required to associate the stored XML document with all other XUIs of the user. Equally well, the XML document may be specific only for a sub-set of the XUIs of the user, and then it may only be required to associate the XML document with those XUIs of the user for which the XML document is specific. Further XUIs, for which the XML document is not specific, may still have their own (XUI-specific) data. Furthermore, it may also be possible that a certain XUI is associated with an XML document stored under a Primary XUI and additionally possesses a further XUI-specific XML document stored under this certain XUI.

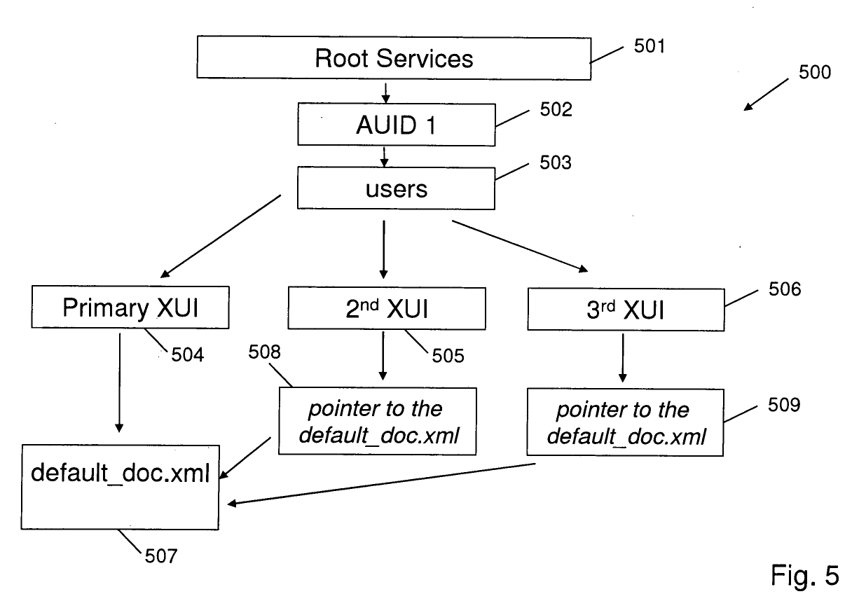

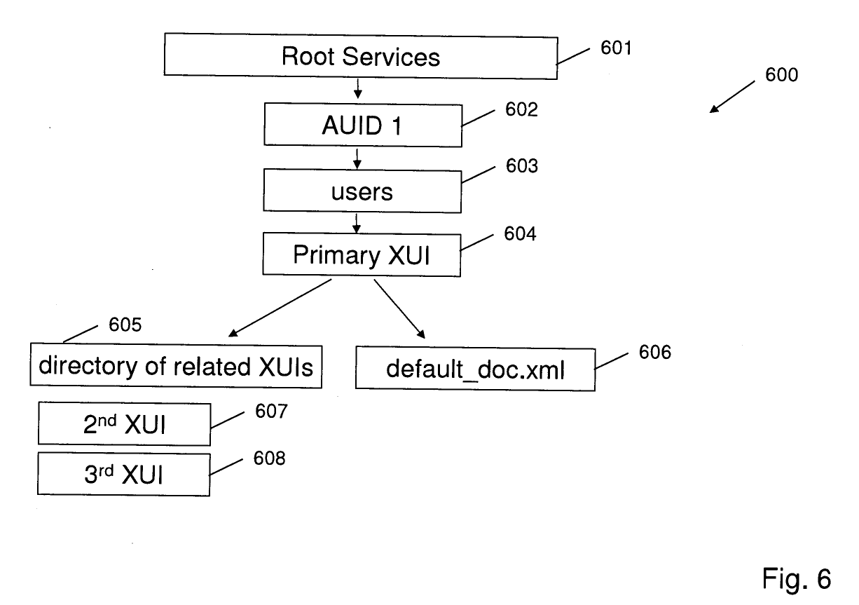

Returning to step 402 of FIG. 4, two different approaches on how to associate the XML document stored under the Primary XUI also with other XUIs that identify the same user, or, in other words, to map the Primary XUI to all the related XUIs, will now be described with reference to FIGS. 5 and 6.

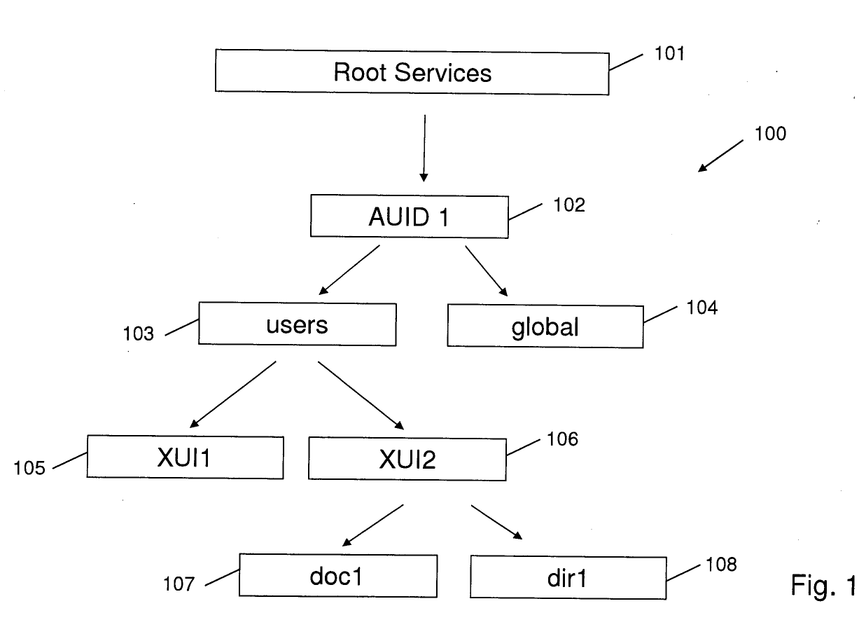

FIG. 5 schematically illustrates an exemplary directory tree 500 according to a first approach of associating the XML document 507 (exemplarily denoted as “default_doc.xml”) stored under the Primary XUI 504 (e.g. the SIP URI “sip:ronald.underwoood@example.com”) with a second XUI 505 (e.g. the TEL URI “tel:+35840998877665”) and a third XUI 506 (e.g. the further SIP URI “sip:ronald@home.com”) via pointer 508 and 509, respectively. Both of these pointers point to the XML document 507. The upper levels of the directory tree 500 are like in the directory 100 of FIG. 1, i.e. there is a Root Services URI 501 (corresponding to the address of an aggregation proxy, e.g. “http://xcap.example.com”.), followed by an Application Unique ID (AUID) 502, identifying the user service or application, e.g. “org.openmobilealliance.poc-groups”, and a “users” directory 503, which contains the different XUIs 504, 505 and 506. Alternative AUIDs are for instance IM history and deferred messages metadata, shared user access policy, shared URI list and shared user profile.

According to this first approach, all XUIs 504, 505 and 506 are parallel and have an own folder or directory within the users tree 503. The XDMS generates a user directory folder for all XUIs 504, 505 and 506, but the actual XML document 507 which may for instance contain an access policy is stored only under the Primary XUI 504 folder, and all related XUIs folders 505 and 506 have a pointer to this folder, provided that there is no XUI-specific information available, which may then be stored under the XUI folders of the respective XUI 505 or 506. Of course, it is also possible that there are both XUI-specific information and a pointer to XML document 507, which is common (specific) to XUI 504, 505 and 506, under one or both XUI folders of XUI 505 and 506. Furthermore, it may be possible that there exist further XUIs for which XML document 507 is not specific, and the XUI-specific XML documents of these further XUIs may then be stored under these further XUIs, respectively, for instance also below the users tree 503 in FIG. 5, e.g. besides the XUIs 504, 505 and 506.

In this approach, the XDMS may have to be prepared to and able to find the pointer information instead of the target document which was originally requested. The possible XPATH part (for accessing only an XML fragment) of the XCAP URI is then applied to the referenced directory and document 507 by the pointer 508 or 509.

FIG. 6 schematically illustrates an exemplary directory tree 600 according to a second approach of associating the XML document 606 (exemplarily denoted as “default_doc.xml”) stored under the Primary XUI 604 (e.g. the SIP URI “sip:ronald.underwoood@example.com”) with a second XUI 607 (e.g. the TEL URI “tel:+35840998877665”) and a third XUI 608 (e.g. the further SIP URI “sip:ronald@home.com”) via a specific directory folder 605. This folder is stored under the Primary XUI 604 to indicate that its entries, the second XUI 607 and the third XUI 608, are associated with the Primary XUI and thus can be used to identify XML document 606 that is only stored under the Primary XUI 604. The upper levels of the directory tree 600 are like in the directory 100 of FIG. 1, or the directory 500 of FIG. 5, i.e. there is a Root Services URI 601 (corresponding to the address of an aggregation proxy, e.g. “http://xcap.example.com”.), followed by an AUID 602, identifying the user service or application, e.g. “org.openmobilealliance.poc-groups”, and a “users” directory 603, which, in this exemplary case, only contains the Primary XUI 604. Alternative AUIDs are for instance IM history and deferred messages metadata, shared user access policy, shared URI list and shared user profile.

According to this second approach, thus only the Primary XUI 604 has an own folder, and the related XUIs 607 and 608 are stored under it as separate folders. The default document 606 is directly stored under the Primary XUI 604. Additional, XUI-specific XML documents (i.e. XML documents that only pertain to the second XUI or third XUI) may then be stored under the folders 607 and 608. Furthermore, it may be possible that there exist further XUIs for which XML document 606 is not specific, and the XUI-specific XML documents of these further XUIs may then be stored under these further XUIs, respectively, for instance also below the users tree 603 in FIG. 6, but besides the Primary XUI 604.

In this approach, future extension may be easier since all data belonging to a user is eventually under the same directory. To simplify and/or speed up the process of finding a related XUI stored under the Primary XUI 604 (e.g. XUIs 607 or 608) for the XDMS, an index document may be provided, which may for instance describe, for each XUI, under which Primary XUI it is stored.

With respect to both approaches described above, in addition to reading the pointer 508 or 509 (see FIG. 5) or searching from possible sub-directories 605 (see FIG. 6), an alternative mapping of XUIs to the Primary XUI for the XDMS may be to utilize a Global Document to search for a user's aliases (especially the Primary XUI information). The Global Document contains combined information of all the directories, and so it will be easy for the XDMS to find out the correct document and mapping to the Primary XUI. The Global Document may for instance be stored under the global tree 104 of FIG. 1.

FIG. 7 illustrates an exemplary use case of the present invention. A user 701, called Ronald, has multiple identities: two SIP URIs, “sip:ronald.underwood@example.com” and “ronald@home.com”, and a TEL URI “tel:+35840998877665”. The XDM client of user 701 issues a PUT request 702 towards XDMS server 703. In this request, the XML document “access.xml” is identified by an XCAP URI “org.openmobilealliance.access-rules/users/sip:ronald-underwood@example.com/access.xml”. Therein, it is exemplarily assumed that the SIP URI “sip:ronald.underwood@example.com” is the Primary XUI, which is always used by the XDM client of user 701 when manipulating data that is or is to be stored at XDMS 703, and that this XML document is specific for all identities of user 701. At XDMS 703, in response to the PUT request 702, the XML document “access.xml” is stored under the Primary XUI, as illustrated in box 704, which can be understood to reflect the directory structure at the XDMS via three XCAP URIs. As can be seen from these XCAP URIs, for the two other XUIs of user 701, pointers (“pointer_to_default_doc.xml”) have been established and stored under the respective XUIs, which pointers point to the XML document (“access.xml”) stored under the Primary XUI, as described above with reference to FIG. 5 (therein, in FIG. 7, the document “access.xml” represents the default document 507 in FIG. 5).

Now, if a further user 705 wants to invite user 701 to a communication session, it issues an INVITE request 706 towards user 701 via a SIP/IP core, yet to be routed to an Application Server (AS) 707 at the user's (701) home network. The request from user 705 includes a SIP URI “sip:ronald@home.com” that is known to user 705. To obtain access information related to user 701, the AS then sends an XCAP GET request 708 to XDMS 703. In the GET request 708, the AS identifies the XML document “access.xml” to be retrieved in an XCAP URI, which contains the SIP URI “sip:ronald@home.com” as a XUI according to the SIP request URI. This XUI is not the Primary XUI, under which the XML document “access.xml” has been stored by XDMS 703 in response to the user's 701 PUT request 702. Nevertheless, since an association (the pointer “pointer_to_default_doc.xml”, exemplarily embodied as XML document) has been created between the XML document “access.xml” and the other XUIs of user 701 that are not the Primary XUI, the XDMS is able to retrieve the XML document “access.xml” even when the XCAP URI contains an XUI differing from the Primary XUI.

The present invention can be deployed in the context of a CPM architecture, where the XDM architecture with the concept of a Primary XUI can then for instance be used to store XML documents e.g. at CPM enabler-specific XDM servers (see for instance enabler-specific XDM server 204 of FIG. 2) containing e.g. a common set of user preferences for all or a subset of a CPM user's CPM addresses.

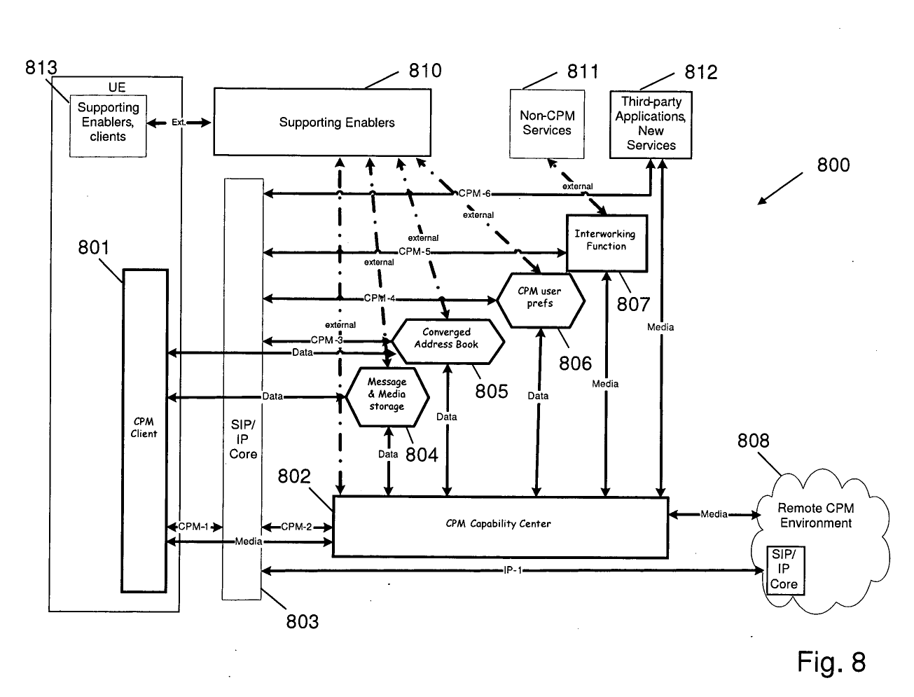

FIG. 8 is a schematic block diagram of a CPM architecture 800 (as described in document “Converged IP Messaging Architecture”, Open Mobile Alliance, Draft Version 1.0, 20 Mar. 2007, document code “OMA-AD-CPM-V1_{—}0-20070320-D).

CPM client 801, which may for instance be comprised in a UE, allows a user to interact with other CPM components, such as for instance the CPM capability center 802, which performs the main logic and control of the CPM architecture. The CPM capability center 802 provides the CPM service based on services from other CPM components and also from external entities, such as for instance a remote CPM environment 808.

The message & media storage entity 804 includes both management and storage functionalities and can be accessed directly and indirectly by CPM client 801 and CPM capability center 802. The converged address book entity 805 handles and synchronizes the user's address book, which may be relevant in case of the user owning several devices. The CPM user preferences entity 806 supports user preferences relating to the CPM services. Interworking function 807 enables communication with external non-CPM services 811, such as for instance the Short Message Service (SMS) or the Multimedia Messaging Service (MMMS). Third party applications 812 use CPM to deliver value added services. Supporting enablers 810 are used to support CPM. Examples of such supporting enablers are XDM or Presence. The supporting enablers 810 may for instance provide an interface for client 813 in the UE to manage data stored in the CPM user preferences entity 806.

SIP/IP core 803 allows various kinds of communication via the components of the CPM architecture based on the SIP. For instance, CPM session signalling and message exchange between CPM client 801 and CPM capability center 802 is based on the SIP/IP core 803. Furthermore, it allows subscription to and notification of modifications of XML documents stored in the enabler-specific XDMS or shared XDMS.

The CPM architecture 800 of FIG. 8 may reuse basically all components of the XDM architecture 200 of FIG. 2. In addition, there may be new XDMSs for all CPM needed data management components (e.g. the CPM user preferences entity 806, the converged address book entity 805 and the message and media storage entity 804) if they don't fit well inside some already defined XDMSs.

The CPM supporting enablers entity 810 may implement among other things the XDM aggregation proxy 202 (see FIG. 2) and may contain shared XDMSs. The CPM supporting enablers client 813 at the UE may implement inter alia XDM client functionality. The CPM user preferences entity 806 may implement the XDMS (either the shared XDMS 203 or the enabler-specific XDMS 204, see FIG. 2). It may be accessed by the CPM supporting enablers client 813 via the aggregation proxy implemented by the CPM supporting enablers entity 810 using the XCAP. The CPM capability center 802 may implement the enabler-specific server 205 of FIG. 2.

If the XDM architecture is implemented in the CPM architecture 800 of FIG. 8, and if a Primary XUI is introduced, it is possible to manage, for instance, the CPM user preferences 806 even in case of multiple communication addresses (corresponding to XUIs) of a user.

The invention has been described above by means of exemplary embodiments. It should be noted that there are alternative ways and variations which are obvious to a skilled person in the art and can be implemented without deviating from the scope and spirit of the appended claims.

Furthermore, it is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may for instance be implemented in one or more digital signal processors, application specific integrated circuits, field programmable gate arrays or other programmable devices. The computer software may be stored in a variety of storage media of electric, magnetic, electro-magnetic or optic type and may be read and executed by a processor, such as for instance a microprocessor. To this end, the processor and the storage medium may be coupled to interchange information, or the storage medium may be included in the processor.

What is claimed is:

1. A method, comprising:
manipulating data that is or is to be stored at a server, which data has to be identifiable at said server via a data identifier that comprises an entity identity identifying an entity, wherein a set of entity identities identifying said entity exists and comprises a primary entity identity and one or more other entity identities, wherein said data is specific for said set of entity identities, and wherein said data is always identified in said manipulating via a data identifier comprising said primary entity identity.

2. The method according to claim 1, wherein said manipulating of said data comprises at least one of putting, retrieving, deleting and changing said data.

3. The method according to claim 1, wherein said data is a document or a part thereof that is or is to be stored at an extensible markup language document management server, wherein said data identifier is an extensible markup language configuration access protocol uniform resource identifier and wherein said entity identities are extensible markup language configuration access protocol user identities.

4. The method according to claim 1, wherein said primary entity identity is a default entity identity.

5. The method according to claim 1, wherein said data describes a common set of preference settings for all or a subset of an entity's entity identities.

6. The method according to claim 1, wherein said data describes a common address book for all or a subset of an entity's entity identities.

7. The method according to claim 1, wherein said entity identities are said entity's converged internet protocol messaging addresses.

8. A computer-readable medium having a computer program stored thereon, the computer program comprising:
instructions operable to cause a processor to manipulate data that is or is to be stored at a server, which data has to be identifiable at said server via a data identifier that comprises an entity identity identifying an entity, wherein a set of entity identities identifying said entity exists and comprises a primary entity identity and one or more other entity identities, wherein said data is specific for said set of entity identities, and wherein said data is always identified in said manipulating via a data identifier comprising said primary entity identity.

9. The computer-readable medium according to claim 8, wherein said data is a document or a part thereof that is or is to be stored at an extensible markup language document management server, wherein said data identifier is an extensible markup language configuration access protocol uniform resource identifier and wherein said entity identities are extensible markup language configuration access protocol user identities.

10. A device, comprising:
a processing unit configured to manipulate data that is or is to be stored at a server, which data has to be identifiable at said server via a data identifier that comprises an entity identity identifying an entity, wherein a set of entity identities identifying said entity exists and comprises a primary entity identity and one or more other entity identities, wherein said data is specific for said set of entity identities, and wherein said processing unit is further configured to identify said data in said manipulating always via a data identifier comprising said primary entity identity.

11. The device according to claim 10, wherein said data is a document or a part thereof that is or is to be stored at an extensible markup language document management server, wherein said data identifier is an extensible markup language configuration access protocol uniform resource identifier and wherein said entity identities are extensible markup language configuration access protocol user identities.

12. A method, comprising:
storing data at a server, which data has to be identifiable at said server via a data identifier that comprises an entity identity identifying an entity, wherein a set of entity identities identifying said entity exists and comprises a primary entity identity and one or more other entity identities, wherein said data is specific for said set of entity identities, wherein said data is stored only under said primary entity identity, and wherein said data is associated with said other entity identities so that said data is also identifiable via a data identifier comprising one of said other entity identities.

13. The method according to claim 12, wherein said data stored under said primary entity identity is associated with said other entity identities by providing, under each of said other entity identities, a pointer pointing to said data stored under said primary entity identity.

14. The method according to claim 13, wherein a unit is prepared to find said pointer instead of said data when identifying said data via said data identifier that comprises one of said other entity identities.

15. The method according to claim 12, wherein said primary entity identity and said other entity identities are stored in the same level of a directory structure.

16. The method according to claim 15, wherein a global document comprises information on said directory structure, and wherein a mapping between said other entity identities and said primary entity identity is derivable from said global document.

17. The method according to claim 12, wherein said data stored under said primary entity identity is associated with said other entity identities by storing said other entity identities under said primary entity identity.

18. The method according to claim 17, further comprising:
providing an index mapping said other entity identities to said primary entity identity.

19. The method according to claim 18, wherein said index is used to identify said data via said data identities.

20. The method according to claim 17, wherein a global document comprises information on a directory structure in which said entity identities are stored, and wherein a mapping between said other entity identities and said primary entity identity is derivable from said global document.

21. The method according to claim 12, wherein said primary entity identity is a default entity identity.

22. The method according to claim 12, wherein said data is a document or a part thereof that is or is to be stored at an extensible markup language document management server, wherein said data identifier is an extensible markup language configuration access protocol uniform resource identifier and wherein said entity identities are extensible markup language configuration access protocol user identities.

23. The method according to claim 12, wherein said data describes a common set of preference settings for all or a subset of an entity's entity identities.

24. The method according to claim 12, wherein said data describes a common address book for all or a subset of an entity's entity identities.

25. The method according to claim 12, wherein said entity identities are said entity's converged internet protocol messaging addresses.

26. A computer-readable medium having a computer program stored thereon, the computer program comprising:
instructions operable to cause a processor to store data at a server, which data has to be identifiable at said server via a data identifier that comprises an entity identity identifying an entity, wherein a set of entity identities identifying said entity exists and comprises a primary entity identity and one or more other entity identities, wherein said data is specific for said set of entity identities, wherein said data is stored only under said primary entity identity, and wherein said data is associated with said other entity identities so that said data is also identifiable via a data identifier comprising one of said other entity identities.

27. The computer-readable medium according to claim 26, wherein said data is a document or a part thereof that is or is to be stored at an extensible markup language document management server, wherein said data identifier is an extensible markup language configuration access protocol uniform resource identifier and wherein said entity identities are extensible markup language configuration access protocol user identities.

28. A device, comprising:
a storage unit configured to store data at a server, which data has to be identifiable at said server via a data identifier that comprises an entity identity identifying an entity, wherein a set of entity identities identifying said entity exists and comprises a primary entity identity and one or more other entity identities, wherein said data is specific for said set of entity identities, wherein said data is stored only under said primary entity identity, and wherein said data is associated with said other entity identities so that said data is also identifiable via a data identifier comprising one of said other entity identities.

29. The device according to claim 28, wherein said data is a document or a part thereof that is or is to be stored at an extensible markup language document management server, wherein said data identifier is an extensible markup language configuration access protocol uniform resource identifier and wherein said entity identities are extensible markup language configuration access protocol user identities.

30. A system, comprising a device according to claim 10 and a device according to claim 28.

31. The system according to claim 30, wherein said data is a document or a part thereof that is or is to be stored at an extensible markup language document management server, wherein said data identifier is an extensible markup language configuration access protocol uniform resource identifier and wherein said entity identities are extensible markup language configuration access protocol user identities.
